(19) United States
(12) Patent Application Publication
(10) Pub. No.: US 2018/0286606 A1
(43) Pub. Date: Oct. 4, 2018

(54) KEYBOARD DEVICE

(71) Applicant: Primax Electronics Ltd., Taipei (TW)

(72) Inventor: Yu-Ming LIN, Taipei (TW)

(21) Appl. No.: 15/684,136

(22) Filed: Aug. 23, 2017

(30) Foreign Application Priority Data
Mar. 31, 2017 (TW) 106111016

(51) Int. Cl. H01H 13/7065; H01H 13/84

(52) U.S. Cl. CPC H01H 13/7065; H01H 13/86; H01H 13/84

(57) ABSTRACT

The present invention provides a keyboard device, including an elastic sheet-like member, a keycap configured to hold the elastic sheet-like member, a membrane circuit board disposed below the keycap, a key baseboard disposed below the membrane circuit board, and a positioning frame cover disposed above the elastic sheet-like member. The positioning frame cover and the key baseboard hold the keycap and the membrane circuit board in an up-and-down direction. The keycap is evenly born on the elastic sheet-like member held by the keycap. A shaking and unstable phenomenon does not occur and the elastic sheet-like member can block external foreign matters from falling into the keyboard device.

### FIELD OF THE INVENTION

The present invention relates to the field of input devices, and in particular, to a keyboard device.

### BACKGROUND OF THE INVENTION

Common peripheral input apparatuses of a computer include a mouse device, a keyboard device, a trackball device, and the like. The keyboard device can be used by users to directly input words and symbols to the computer and is therefore attracted with great importance.

The structure and function of a conventional keyboard device are described first. Referring to FIG. 1 to FIG. 3, FIG. 1 is a schematic structural view of the appearance of a conventional keyboard, FIG. 2 is a schematic three-dimensional diagram of a part of the structure of the keyboard device shown in FIG. 1, and FIG. 3 is a schematic three-dimensional exploded view of a part of the structure of the keyboard device shown in FIG. 1. For clearer presentation, only a part of a key frame, a single key structure, and the structure of related elements are drawn in FIG. 2 and FIG. 3. The conventional keyboard device 1 includes a plurality of key structures 10, a key baseboard 11, a membrane circuit board 12, and a key frame 13. A plurality of membrane switches 121 corresponding to the plurality of key structures 10 is provided on the membrane circuit board 12. Each key structure 10 includes a keycap 101, a scissor-type connecting element 102, and an elastic member 103. The scissor-type connecting element 102 is connected between the keycap 101 and the key baseboard 11 and includes a first frame 1021 and a second frame 1022 pivotally connected to the first frame 1021. Therefore, the first frame 1021 and the second frame 1022 may shake relative to each other. In addition, the elastic member 103 is disposed between the keycap 101 and the key baseboard 11 and has a pressing part (not shown).

When the keycap 101 of any key structure 10 is pressed and move downward relative to the key baseboard 11, the first frame 1021 and the second frame 1022 of the scissor-type connecting element 102 change from an open state to a closed state, and the keycap 101 that moves downward squeezes the elastic member 103, so that the pressing part of the elastic member 103 presses against and triggers the corresponding membrane switch 121, and the keyboard device 1 generates a corresponding key signal. When the keycap 101 of the key structure 10 is no longer pressed, the keycap 101 moves upward relative to the key baseboard 11 under the stress of an elastic force of the elastic member 103. In this case, the first frame 1021 and the second frame 1022 change from the closed state to the open state, and the keycap 101 is reset to an original position.

However, because the conventional keyboard 1 needs to be provided with the scissor-type connecting element 102 and/or the elastic member 103, it is difficult to decrease the thickness of the conventional keyboard 1. Further, because the keycap 101 cannot be evenly supported, the keycap 101 has a shaking and unstable phenomenon in both a fore-and-aft direction and a left-to-right direction, and consequently, the feeling of a user in operation is affected. In addition, dust and water drops outside the keyboard device easily fall into the keyboard device 1 from the periphery of the shaking keycap 101, resulting in a poor contact of the membrane circuit board 12. Therefore, the conventional keyboard device 1 has room for improvement.

### SUMMARY OF THE INVENTION

The present invention is mainly directed to provide a keyboard device of which a keycap is born on an elastic sheet-like member that is held by the keycap of the keyboard device, so that the keycap does not have a loose and shaking phenomenon, and the keyboard device may be isolated from external foreign matters (such as dust and water drops) that fall into the keyboard device, thereby reducing occurrence of problems related to a circuit.

In a preferred embodiment, the present invention provides a keyboard device, including:

an elastic sheet-like member;

a keycap, including a first shell and a second shell, where the first shell and the second shell hold the elastic sheet-like member together, where the second shell includes a pressing part, and the pressing part extends downward from a bottom surface of the second shell;

a membrane circuit board, disposed below the keycap and including a membrane switch that corresponds to the pressing part and that is configured to press against the pressing part when the keycap is pressed down;

at least one support component, configured to support the elastic sheet-like member upward when the keycap is pressed down; and

a positioning frame cover, disposed above the elastic sheet-like member and including a ring wall and a limiting through hole surrounded by the ring wall, where the keycap is disposed in the limiting through hole and protrudes the limiting through hole, where the ring wall is provided with at least one positioning prick post penetrating through the elastic sheet-like member.

### BRIEF DESCRIPTION OF THE DRAWINGS

FIG. 1 is a schematic structural view of the appearance of a conventional keyboard device;

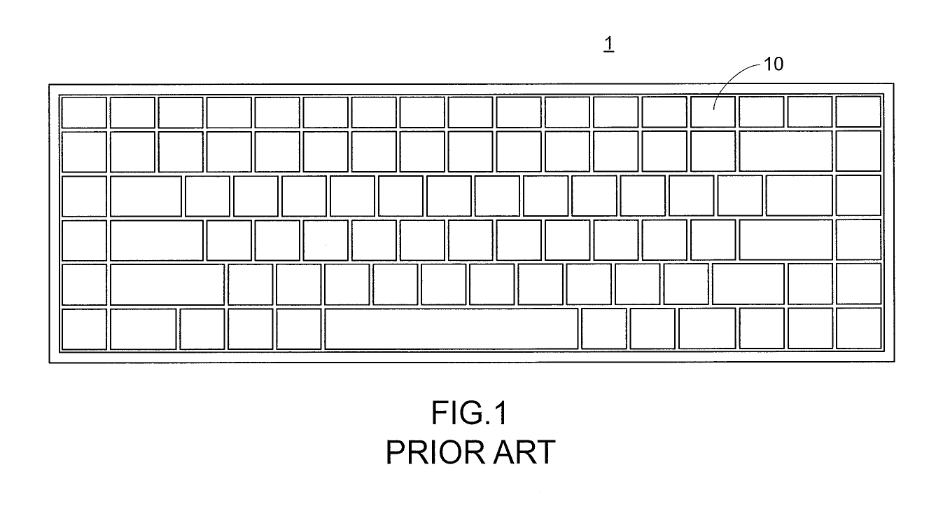

FIG. 2 is a schematic three-dimensional diagram of a part of the structure of the keyboard device shown in FIG. 1;

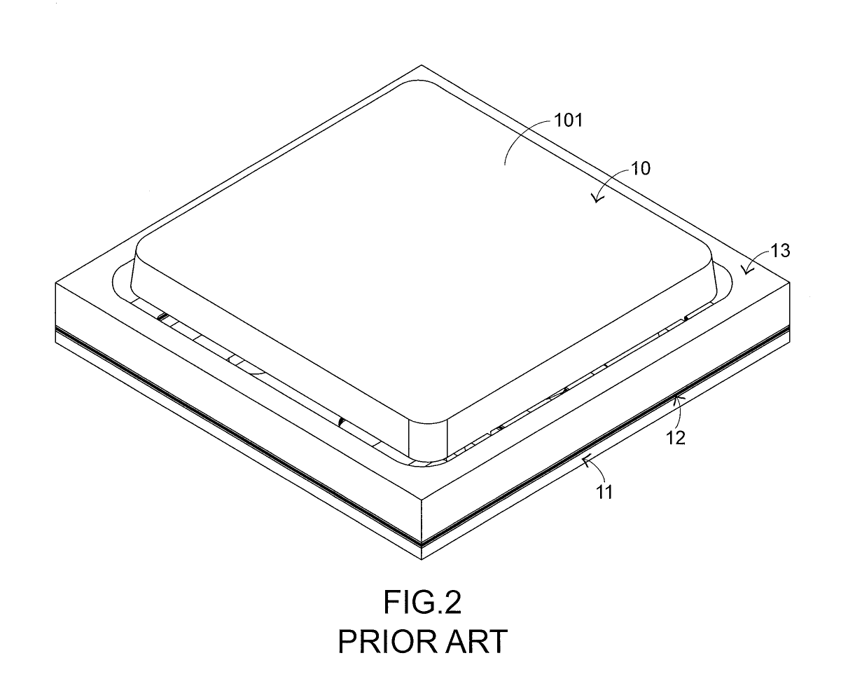

FIG. 3 is a schematic three-dimensional exploded view of a part of the structure of the keyboard device shown in FIG. 1;

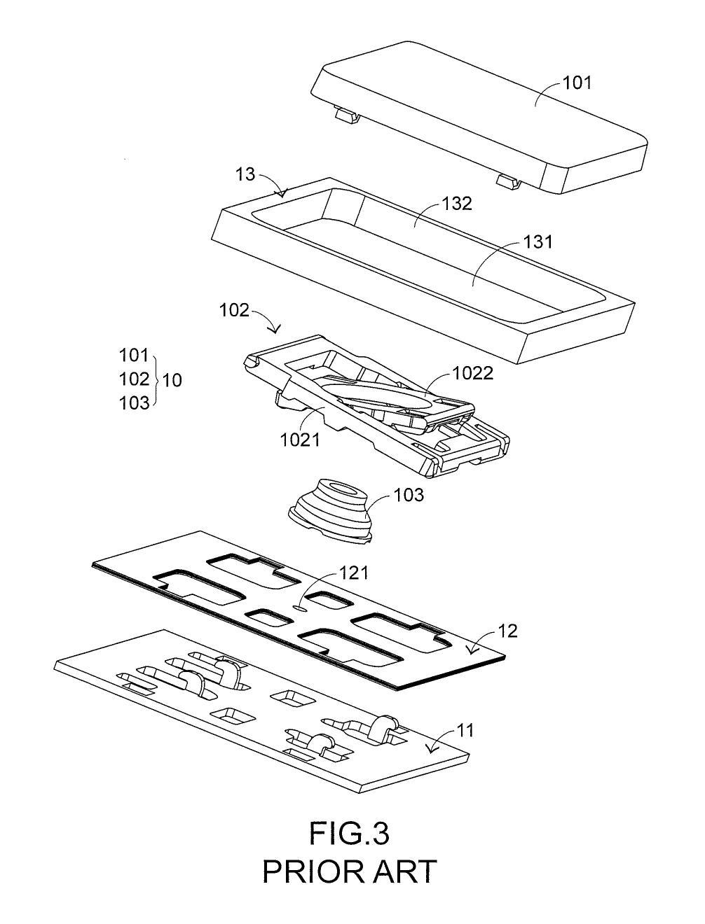

FIG. 4 is a schematic structural view of the appearance of a keyboard device in a preferred embodiment according to the present invention;

FIG. 5 is a schematic three-dimensional diagram of a part of the structure of the keyboard device shown in FIG. 4;

FIG. 6 is a schematic three-dimensional exploded view of a part of the structure of the keyboard device shown in FIG. 5;

FIG. 7 is a schematic three-dimensional exploded view of a part of the structure of the keyboard device shown in FIG. 5 from another angle;

FIG. 8 is a schematic structural diagram of an elastic sheet-like member held by a first shell and a second shell of a keycap of the keyboard device shown in FIG. 5;

FIG. 9 is a schematic structural diagram of a part of the structure of the keyboard device shown in FIG. 5; and

FIG. 10 is a schematic sectional view of a part of the structure of the keyboard device shown in FIG. 5.

### DETAILED DESCRIPTION OF THE PREFERRED EMBODIMENT

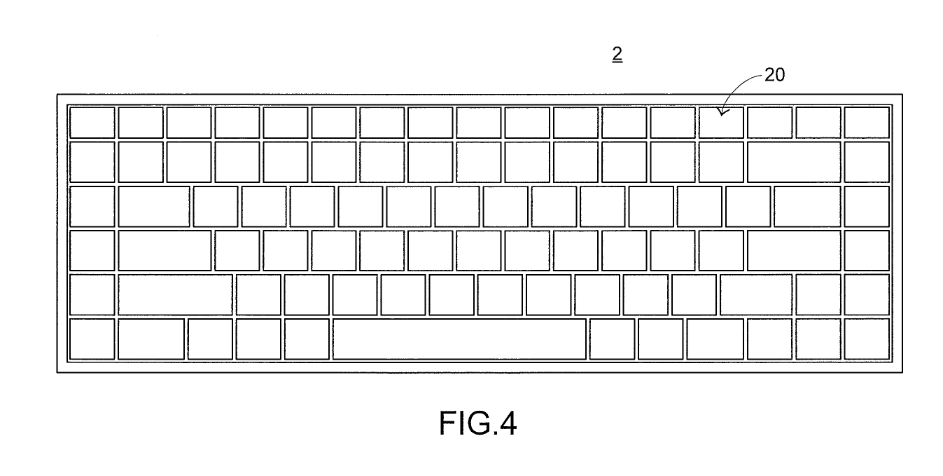

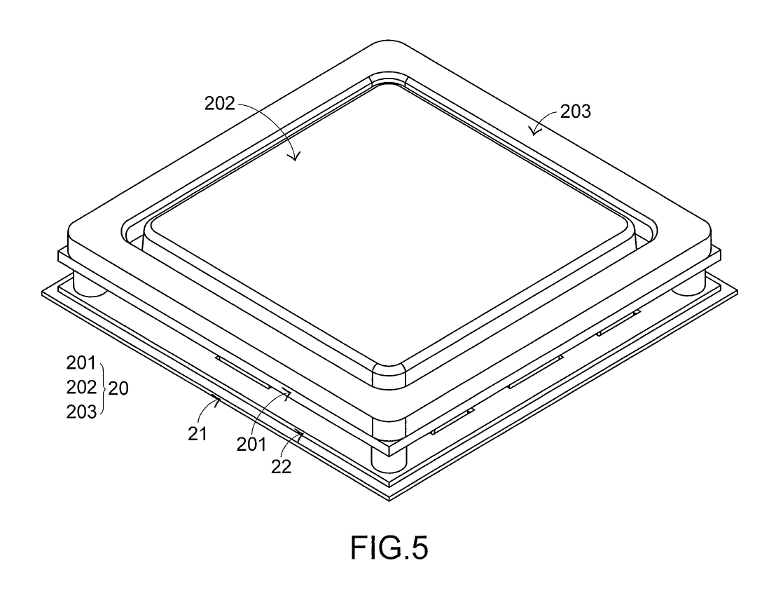

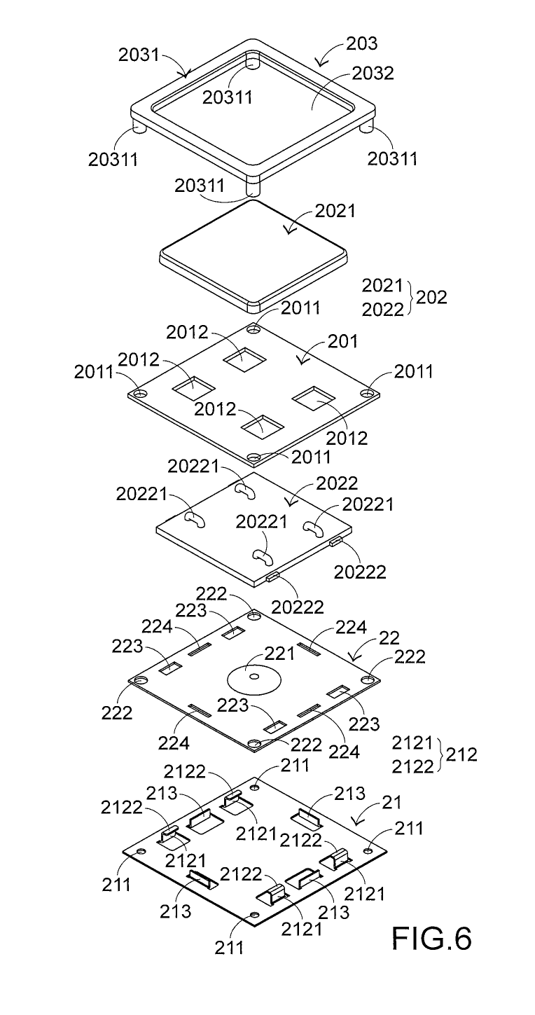

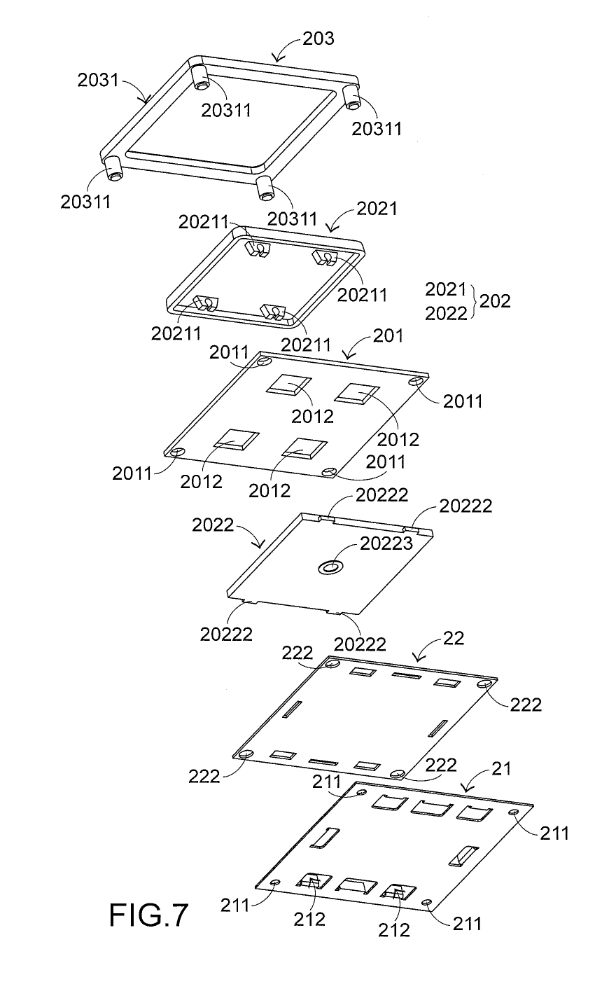

Referring to FIG. 4 to FIG. 7, FIG. 4 is a schematic structural view of the appearance of a keyboard device in a preferred embodiment according to the present invention, FIG. 5 is a schematic three-dimensional diagram of a part of the structure of the keyboard device shown in FIG. 4, FIG. 6 is a schematic three-dimensional exploded view of a part of the structure of the keyboard device shown in FIG. 5, and FIG. 7 is a schematic three-dimensional exploded view of a part of the structure of the keyboard device shown in FIG. 5 from another angle. For clearer presentation, only a single key structure and the structure of related elements are drawn in FIG. 5 to FIG. 7. A keyboard device 2 includes a plurality of key structures 20, a membrane circuit board 22, and a key baseboard 21 disposed below the membrane circuit board 22. The key structures 20 may be classified into common keys, number keys, and function keys, which are respectively used to be pressed by fingers of a user and enable the keyboard device 2 to generate a corresponding key signals to a computer, so that the computer perform corresponding functions. For example, the common keys are configured to input symbols such as English letters, the number keys are configured to input numbers, and the function keys, such as F1 to F12, are configured to provide various shortcut functions.

Further, each key structure 20 includes an elastic sheet-like member 201, a keycap 202, and a positioning frame cover 203. The keycap 202 is disposed above the membrane circuit board 22 and includes a first shell 2021 and a second shell 2022. The first shell 2021 and the second shell 2022 hold the elastic sheet-like member 201 together, and the periphery of the held elastic sheet-like member 201 is exposed out of the keycap 202. The second shell 2022 includes a pressing part 20223, and the pressing part 20223 extends downward from a bottom surface of the second shell 2022.

Still, the membrane circuit board 22 includes a plurality of membrane switches 221 that respectively correspond to the keycaps 202. In this preferred embodiment, the membrane switches 221 are in the form of switch elastic sheets, such as in the form of a metal dome sheet, which is usually referred to as a metal dome, and no limitation is imposed on the foregoing. In addition, the positioning frame cover 203 is disposed above the elastic sheet-like member 201, and includes a ring wall 2031 and a limiting through hole 2032 surrounded by the ring wall 2031. The keycap 202 is disposed in the limiting through hole 2032 and protrudes outside the limiting through hole 2032. The ring wall 2031 is provided with a plurality of positioning prick posts 20311 that extend downward, and the positioning prick posts 20311 respectively penetrate downward through the elastic sheet-like member 201 and the membrane circuit board 22 sequentially and are connected to the key baseboard 21. However, the form of the membrane switch is not limited thereto, and any person skilled in the art can make any equivalent modification according to an actual application requirement.

Preferably, but not limited thereto, the elastic sheet-like member 201 is made of a woven cloth material, and the periphery of the elastic sheet-like member 201 has first positioning through holes 2011 corresponding to the positioning prick posts 20311, the membrane circuit board 22 has second positioning through holes 222 corresponding to the positioning prick posts 20311, and the key baseboard 21 has third positioning through holes 211 corresponding to the positioning prick posts 20311. Therefore, each positioning prick post 20311 of the ring wall 2031 of the positioning frame cover 203 sequentially penetrates downward through the corresponding first positioning through hole 2011, the corresponding second positioning through hole 222, and the corresponding third positioning through hole 211, and is fixedly connected to the corresponding third positioning through hole 211, and the present invention is not limited thereto. In this case, the positioning frame cover 203 and the key baseboard 21 hold the keycap 202, the elastic sheet-like member 201, and the membrane circuit board 22 together in an up-and-down direction, so that elements of the keyboard device 2 are closely stacked and fixed to each other.

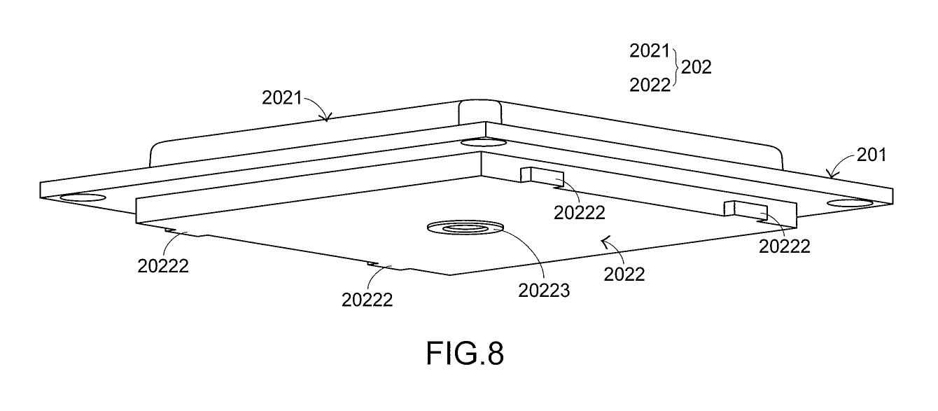

In this preferred embodiment, the first shell 2021 includes a plurality of first catch parts 20211, and the second shell 2022 includes a plurality of second catch parts 20221 that respectively correspond to the first catch parts 20211. The elastic sheet-like member 201 includes a plurality of hollow parts 2012 that respectively correspond to the first catch parts 20211 and the second catch parts 20221. Each first catch part 20211 is engaged with the corresponding second catch part 20221 through the corresponding hollow part 2012, or each second catch part 20221 is engaged with the corresponding first catch part 20211 through the corresponding hollow part 2012, so that the elastic sheet-like member 201 is held between the first shell 2021 and the second shell 2022, as shown in FIG. 8. However, the foregoing is an embodiment in which the first shell 2021 and the second shell 2022 are connected with each other, and the present invention is not limited thereto. Any person skilled in the art may make any equivalent modification according to an actual application requirement.

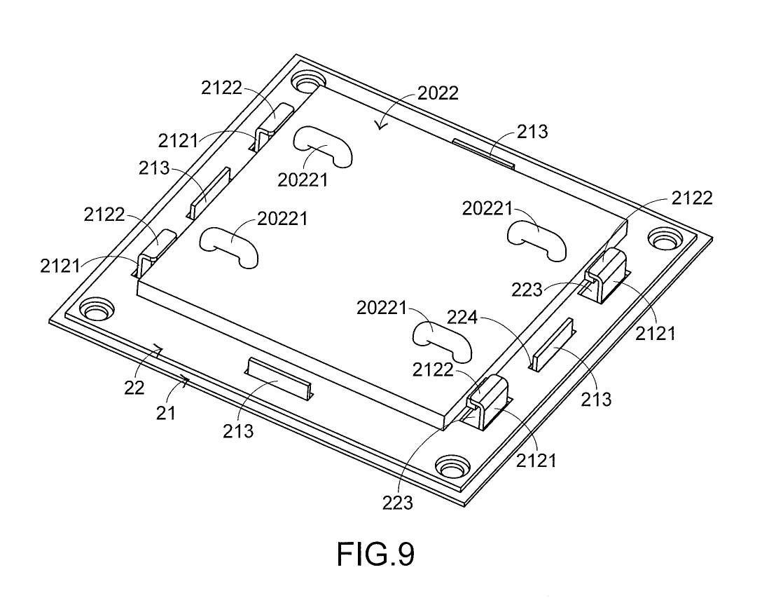

Referring to FIG. 6, FIG. 7, and FIG. 9, FIG. 9 is a schematic structural diagram of a part of the structure of the keyboard device shown in FIG. 5. For clearer presentation, FIG. 9 omits drawing of elements such as the positioning frame cover 203 and the elastic sheet-like member 201. The second shell 2022 further includes a plurality of protruding parts 20222 that laterally extend from the periphery of the second shell 2022. The membrane circuit board 22 further includes a plurality of first penetrating grooves 223, and the key baseboard 21 includes a plurality of support components 212 that respectively corresponds to the first penetrating grooves 223 and penetrates upward through the first penetrating grooves 223 to contact and press against the elastic sheet-like members 201. Still, each support component 212 has a support part 2121 and a bent part 2122 connected to the support part 2121. The support part 2121 penetrates upward through a corresponding first penetrating groove 223 on the membrane circuit board 22, and the bent part 2122 bend in a direction from a top end of the support part 2121 to the keycap 202. An upper surface of the bent part 2122 is used to support the elastic sheet-like member 201, and a lower surface of the bent part 2122 is used to be engaged with a protruding part 20222 corresponding to the second shell 2022, so as to limit a corresponding displacement between the keycap 202 and the key baseboard 21.

Preferably, but not limited thereto, the membrane circuit board 22 further includes a plurality of second penetrating grooves 224, and the key baseboard 21 further includes a plurality of protruding components 213 that respectively correspond to the second penetrating groove 224, extend upward through the second penetrating grooves 224, and are configured to press against the elastic sheet-like member 201. The protruding components 213 and the support components 212 of the key baseboard 21 are disposed at intervals, so as to evenly support the elastic sheet-like member 201 upward.

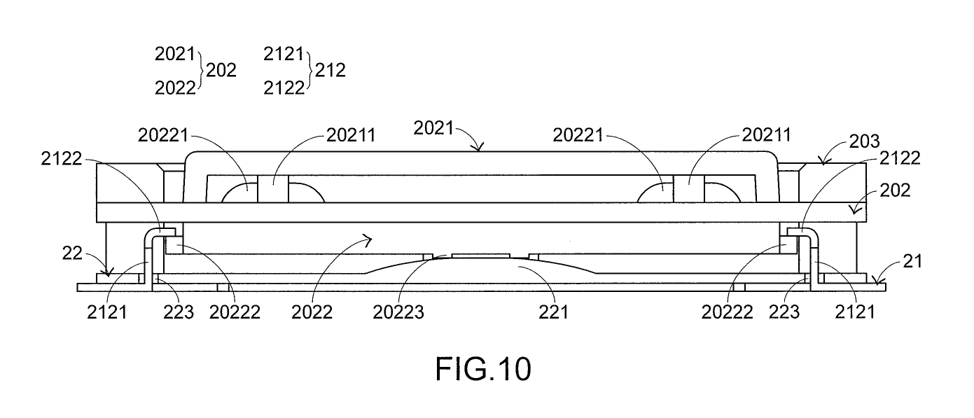

An operating process of the keyboard device 2 of the present invention is described below. Referring to FIG. 10, FIG. 10 is a schematic sectional view of a part of the structure of the keyboard device shown in FIG. 5. When any keycap 202 is pressed down by a user, the pressing part 20223 of the second shell 2022 of the keycap 202 presses against a corresponding membrane switch 221 on the membrane circuit board 22, so as to enable the keyboard device 2 to generate a corresponding key signal. In this case, the elastic sheet-like member 201 held by the keycap 202 is also pulled down and generates an elastic force as the keycap 202 moves downward. After the user releases the keycap 202, the keycap 202 moves upward to an original position under an upward pressing elastic force of the membrane switch 221 and/or an elastic force of the elastic sheet-like member 201.

The elastic sheet-like member 201 is held by the first shell 2021 and the second shell 2022 of the keycap 202, and therefore, in a process of moving upward or downward, the keycap 202 may be stably born by the elastic sheet-like member 201, and the keycap 202 does not have a loose and shaking phenomenon, thereby improving the feeling of a user in operation. It may be known from the foregoing description that a scissor-type connecting element and/or an elastic member do not need to be disposed on the keyboard device 2 of the present invention, so that the overall thickness can be effectively reduced. In addition, the elastic sheet-like member 201 is integrated with the keycap 202 and can also be effectively isolated from external foreign matters (such as dust and water drops) that fall from the periphery of the keycap 202 or the gap between the keycaps 202 into the membrane circuit board 22 below, thereby reducing occurrence of problems related to a circuit.

Additionally, it should be noted in particular that in the present invention, the first shell 2021 and the second shell 2022 of the keycap 202 hold the elastic sheet-like member 201 so that the elastic sheet-like member 201 is integrated with the keycap 202. Compared with a manner in which the elastic sheet-like member is adhered to and fastened to the keycap by means of glue, the present invention can effectively maintain the inherent elastic feature of the elastic sheet-like member 201, and especially when the elastic sheet-like member 201 is made of a woven cloth material, an effect of maintaining the inherent elastic feature of the elastic sheet-like member 201 is more notable.

The foregoing descriptions are only preferred embodiments of the present invention, but are not intended to limit the claims of the present invention. Any equivalent changes or modifications made without departing from the spirit of the present invention shall fall within the claims of the present invention.

What is claimed is:

1. A keyboard device, comprising:
an elastic sheet-like member;
a keycap, comprising a first shell and a second shell, wherein the first shell and the second shell hold the elastic sheet-like member together, wherein the second shell comprises a pressing part, and the pressing part extends downward from a bottom surface of the second shell;
a membrane circuit board, disposed below the keycap and comprising a membrane switch that corresponds to the pressing part and that is configured to press against the pressing part when the keycap is pressed down;
at least one support component, configured to support the elastic sheet-like member upward when the keycap is pressed down; and
a positioning frame cover, disposed above the elastic sheet-like member, and comprising a ring wall and a limiting through hole surrounded by the ring wall, wherein the keycap is disposed in the limiting through hole and protrudes the limiting through hole, wherein the ring wall is provided with at least one positioning prick post penetrating through the elastic sheet-like member.

2. The keyboard device according to claim 1, further comprising a key baseboard, wherein the key baseboard is disposed below the membrane circuit board, and the at least one support component is disposed on the key baseboard and penetrates upward through the membrane circuit board to contact the elastic sheet-like member.

3. The keyboard device according to claim 2, wherein the at least one positioning prick post sequentially penetrates through the elastic sheet-like member and the membrane circuit board and is connected to the key baseboard.

4. The keyboard device according to claim 2, wherein the elastic sheet-like member, the membrane circuit board, and the key baseboard respectively comprise at least one first positioning through hole, at least one second positioning through hole, and at least one third positioning through hole, and the at least one positioning prick post sequentially penetrates through the at least one first positioning through hole, the at least one second positioning through hole, and the at least one third positioning through hole.

5. The keyboard device according to claim 2, wherein the key baseboard comprises at least one protruding component that extends upward, and the at least one protruding component and the at least one support component are disposed at intervals, wherein the at least one protruding component penetrates through the membrane circuit board and is configured to press against the elastic sheet-like member.

6. The keyboard device according to claim 1, wherein each support component has a support part and a bent part connected to the support part, the support part penetrates upward through the membrane circuit board, and the bent part bends in a direction from a top end of the support part to the keycap, wherein the bent part is configured to support the elastic sheet-like member.

7. The keyboard device according to claim 6, wherein the second shell further comprises at least one protruding part, and the at least one protruding part laterally extends from the periphery of the second shell and is engaged with the bent part.

8. The keyboard device according to claim 1, wherein the first shell and the second shell respectively comprise a first catch part and a second catch part, and when the first catch part is engaged with the second catch part, the first shell and the second shell are connected and hold the elastic sheet-like member together.

9. The keyboard device according to claim 8, wherein the elastic sheet-like member has a hollow part corresponding to the first catch part and the second catch part, and one of the first catch part and the second catch part is engaged with the other one of the first catch part and the second catch part by means of the hollow part.

10. The keyboard device according to claim 1, wherein the elastic sheet-like member is made of a woven cloth material.
